(19) United States
(12) Patent Application Publication
(10) Pub. No.: US 2025/0242633 A1
(43) Pub. Date: Jul. 31, 2025

(54) VEHICLE WHEEL STRUCTURE

(71) Applicant: TOYOTA JIDOSHA KABUSHIKI KAISHA, Aichi-ken (JP)

(72) Inventors: Tomoyuki ISHIKAWA, Nisshin-shi (JP); Hideya KUSUNOKI, Gamagori-shi (JP)

(21) Appl. No.: 19/037,285

(22) Filed: Jan. 27, 2025

(30) Foreign Application Priority Data
Jan. 31, 2024 (JP) 2024-013313

(51) Int. Cl. B60B 7/06; B60B 3/00; B60B 7/14

(52) U.S. Cl. CPC B60B 7/065; B60B 3/004; B60B 7/066; B60B 7/14

(57) ABSTRACT

A vehicle wheel structure includes: a wheel configured to support a tire and be assembled to a vehicle; a wheel cover engaged with the wheel at least at a central part of a disc that is a component of the wheel, the wheel cover in a state attached to the wheel including a body formed so as to cover an entire surface, corresponding to an outer side of the vehicle, of the disc when the wheel is assembled to the vehicle and an engaging portion provided on the body and configured to engage with an engaged portion provided at the central part of the disc; and a restricting member configured to restrict movement of the engaging portion in a releasing direction to release engagement with the engaged portion in a state where the engaging portion is engaged with the engaged portion.

### CROSS-REFERENCE TO RELATED APPLICATION

This application claims priority to Japanese Patent Application No. 2024-013313 filed on Jan. 31, 2024, incorporated herein by reference in its entirety.

### BACKGROUND

### 1. Technical Field

The disclosure relates to a vehicle wheel structure.

### 2. Description of Related Art

Generally, for example, a wheel cap described in Japanese Unexamined Patent Application Publication No. 2012-158300 (JP 2012-158300 A) is known. The existing wheel cap has an engaging portion that engages with an engaged portion formed at an outer peripheral part at which a disc and a rim that are components of a wheel of a vehicle are coupled to each other. Then, the existing wheel cap is attached to the wheel in a manner such that the engaged portion and the engaging portion engage with each other at the outer peripheral part of the wheel.

### SUMMARY

Once the vehicle drives, external force that acts in a direction to detach a wheel attachment member, such as the wheel cap and a wheel cover, on the wheel attachment member attached to the wheel can occur due to wind pressure and vibration. In recent years, a wheel to be assembled to a vehicle tends to increase in diameter (increase in size), so large centrifugal force can occur in a wheel attachment member that rotates with the wheel. Incidentally, the existing wheel cap adopts a structure in which the engaged portion and the engaging portion are engaged with each other only at the outer peripheral part of the wheel. For this reason, with the structure of the existing wheel cap, once external force acts on the wheel attachment member, lifting from the disc of the wheel at a central part of the disc particularly occurs. In addition, when centrifugal force acts on the wheel attachment member in which lifting has occurred, there are concerns that the wheel attachment member is easily detached.

The disclosure provides a vehicle wheel structure capable of suppressing detachment of a wheel attachment member attached to a wheel.

An aspect of the disclosure provides a vehicle wheel structure. The vehicle wheel structure includes: a wheel configured to support a tire and be assembled to a vehicle; a wheel attachment member engaged with the wheel at least at a central part of a disc that is a component of the wheel, the wheel attachment member in a state attached to the wheel including a body formed so as to cover a surface, corresponding to an outer side of the vehicle, of the disc when the wheel is assembled to the vehicle and an engaging portion provided on the body and configured to engage with an engaged portion provided at the central part of the disc; and a restricting member configured to restrict movement of the engaging portion in a releasing direction to release engagement with the engaged portion in a state where the engaging portion is engaged with the engaged portion.

With the vehicle wheel structure according to the aspect of the disclosure, the restricting member can restrict movement, in the releasing direction, of the engaging portion engaged with the engaged portion at the central part of the wheel. Thus, even when external force or centrifugal force acts on the wheel attachment member, an engaged state of the engaging portion with the engaged portion is maintained. Therefore, it is possible to suppress detachment of the wheel attachment member from the wheel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view for illustrating a vehicle wheel structure according to a first embodiment;

FIG. 2 is a cross-sectional view taken along the line II-II in FIG. 1;

FIG. 3 is a view for illustrating a wheel;

FIG. 4 is a view for illustrating a wheel attachment member according to the first embodiment;

FIG. 5 is a perspective view for illustrating the wheel attachment member according to the first embodiment;

FIG. 6 is a perspective view for illustrating a restricting member according to the first embodiment;

FIG. 7 is a view for illustrating an engaging portion and a holding portion of the wheel attachment member according to the first embodiment;

FIG. 8 is a view for illustrating a fit holding portion of the restricting member according to the first embodiment;

FIG. 9 is a view for illustrating assembling of the restricting member according to the first embodiment;

FIG. 10 is a view for illustrating assembling of the restricting member according to the first embodiment;

FIG. 11 is a view for illustrating a vehicle wheel structure according to a second embodiment;

FIG. 12 is a view for illustrating a wheel attachment member according to the second embodiment;

FIG. 13 is a view for illustrating the wheel attachment member and a restricting member according to the second embodiment;

FIG. 14 is a view for illustrating assembling of the restricting member according to the second embodiment;

FIG. 15 is a view for illustrating an assembled state of the restricting member according to the second embodiment;

FIG. 16 is a view for illustrating a modification of the first embodiment; and

FIG. 17 is a view for illustrating a modification of the second embodiment.

### DETAILED DESCRIPTION OF EMBODIMENTS

Hereinafter, vehicle wheel structures according to embodiments of the disclosure will be described in details with reference to the attached drawings. The disclosure may be implemented in various forms with various modifications and improvements based on the knowledge of persons skilled in the art, other than the following embodiments.

### 1. First Embodiment

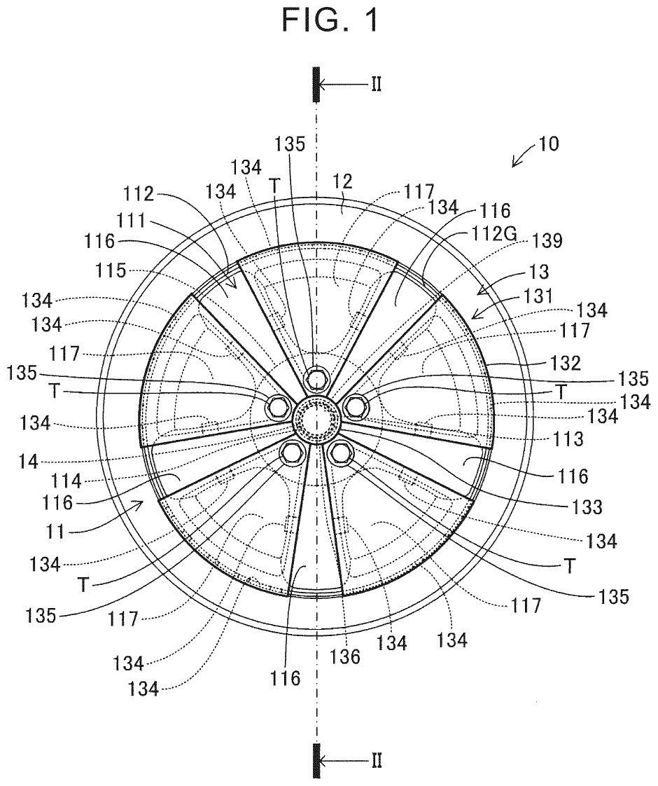

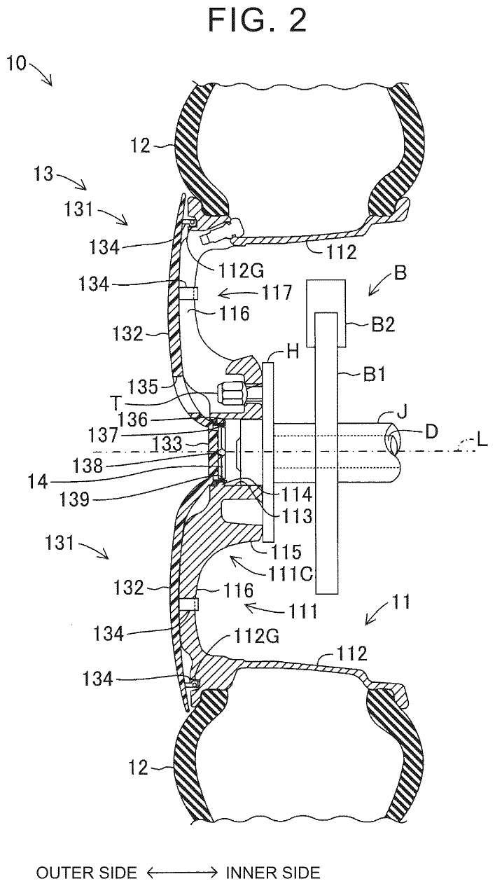

As shown in FIG. 1 and FIG. 2, a vehicle wheel structure 10 according to a first embodiment includes a wheel 11 that is a component of a tire-wheel assembly of a vehicle. The wheel 11 supports a tire 12 and is assembled to the vehicle. Then, the vehicle wheel structure 10 according to the first embodiment includes a wheel cover 13 and a restricting member 14. The wheel cover 13 serves as a wheel attachment member and is attached to the wheel 11. The restricting member 14 is assembled to the wheel cover 13. Here, the vehicle wheel structure 10 described below is an example of a case where the vehicle wheel structure 10 is applied to a tire-wheel assembly that is a drive wheel. A case where the vehicle wheel structure 10 is applied to a tire-wheel assembly that is a drive wheel is illustrated; however, the vehicle wheel structure 10 is, of course, applicable to a tire-wheel assembly that is a driven wheel.

Here, as for the terms “inner side” and “outer side” of the vehicle in the specification and the appended claims, when the wheel 11 is assembled to the vehicle, a side where a vehicle body of the vehicle is located with respect to the wheel 11 is the “inner side” and an opposite side where no vehicle body is located is the “outer side”. In the following description, the side that is the “outer side” in the wheel 11 may also be referred to as “design surface”. In the following description, a direction parallel to a rotation axis L of the tire-wheel assembly shown in FIG. 2 is referred to as “axial direction”, and a direction orthogonal to the rotation axis L is referred to as “radial direction”.

The wheel 11 is made of an alloy of aluminum or the like or made of steel. The wheel 11 is configured to include a disc 111 having a disc shape and an annular rim 112 provided at an outer periphery of the disc 111 and holding the tire 12. In the present embodiment, the wheel 11 is made of an alloy of aluminum or the like, and, as shown in FIG. 2, a case where the wheel 11 is of a one-piece type in which the disc 111 and the rim 112 are integrally molded with each other is illustrated.

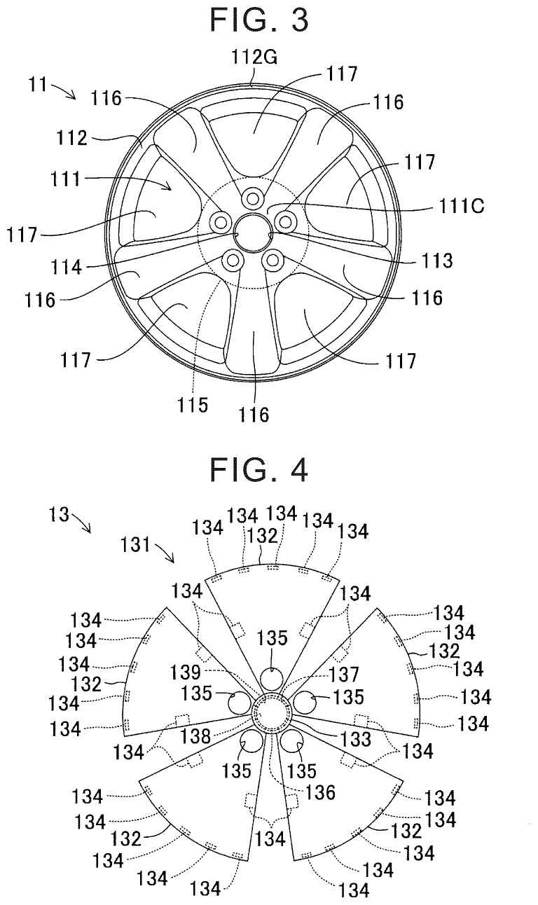

As shown in FIG. 2 and FIG. 3, the disc 111 has a hub hole 113 formed so as to extend along the rotation axis L through a central part 111C of the disc 111. Here, the hub hole 113, for example, can function as a hole for mounting an ornament to be provided on the wheel 11 in a case where no wheel cover 13 is attached.

n engaged portion 114 is provided on an inner periphery of the hub hole 113. The engaged portion 114 engages with engaging portions 136 of the wheel cover 13 (described later). The engaged portion 114 is a projection formed over all around on the inner periphery of the hub hole 113 at a predetermined location in the axial direction. A projection provided to fix an ornament may be used as the engaged portion 114.

The disc 111 includes a hub mounting portion 115 and spokes 116. The hub mounting portion 115 is used to fix the wheel 11 to a hub H. The spokes 116 couple the hub mounting portion 115 with the rim 112. In the present embodiment, a case where the disc 111 includes five spokes 116 radially extending from the hub mounting portion 115 is illustrated.

The disc 111 also has air holes 117 each formed between any adjacent spokes 116. In the present embodiment, as shown in FIG. 3, a case where the disc 111 has five air holes 117 each defined by the two spokes 116, the hub mounting portion 115, and the rim 112 is illustrated. Depending on the layout and shape of the spokes 116, the air hole 117, for example, may be defined by the two spokes 116 and the rim 112 or may be defined by the two spokes 116 and the hub mounting portion 115. Then, the disc 111 and the rim 112, that is, the wheel 11, is fixed to the hub H by fastening members T, that is, hub nuts, hub bolts, or the like, as shown in FIG. 1 and FIG. 2.

Here, as shown in FIG. 2, a disc brake B is provided on the inner side of the wheel 11, more specifically, on the inner side of the hub H coupled to the hub mounting portion 115. The disc brake B includes a brake rotor B1 and a caliper B2. The brake rotor B1 rotates integrally with the wheel 11. The caliper B2 presses a friction member against the brake rotor B1. When the tire-wheel assembly is a drive wheel, the hub H to which the hub mounting portion 115 is fixed is connected to a drive shaft D as shown in FIG. 2. The drive shaft D is accommodated inside an axle J provided so as to extend through the hub H and the brake rotor B1. Then, when the tire-wheel assembly is a drive wheel, the distal end of the drive shaft D is inserted in the hub hole 113.

Each of the wheel cover 13 and the restricting member 14 that make up the vehicle wheel structure 10 is molded from a resin material. As for a resin material to mold the wheel cover 13 and the restricting member 14, the wheel cover 13 and the restricting member 14 may be molded from the same resin material or the wheel cover 13 and the restricting member 14 may be molded from different resin materials.

As shown in FIG. 1 and FIG. 2, the wheel cover 13 is attached so as to cover the air holes 117 of the wheel 11 at the design surface that is the outer side of the wheel 11. As shown in FIG. 4, the wheel cover 13 includes a body 131 as a main element. In the body 131, an outer-side surface may be decorated in a state where the wheel cover 13 is attached to the disc 111 of the wheel 11.

The body 131 has a plurality of body forming members 132 and a coupling portion 133 that couples the body forming members 132 in the circumferential direction of the disc 111 in a state attached to the wheel 11. Thus, the body forming members 132 are combined by the coupling portion 133, and the disc-shaped body 131 is attached to the design surface in the disc 111 of the wheel 11.

Here, in the following description, a case where the body 131 has the plurality of fan-shaped body forming members 132. Specifically, the body 131 has five body forming members 132 in order to respectively cover the five air holes 117 provided in the disc 111 of the wheel 11. The number of the body forming members 132 is not limited and may be two or more. The shape of each of the body forming members 132 is not limited to a fan-shape, and various shapes may be adopted.

In the following description, a case where the coupling portion 133 couples the body forming members 132 at the central part 111C of the disc 111 in a state attached to the wheel 11 is illustrated. However, for example, the coupling portion 133 is, of course, allowed to couple the body forming members 132 at a location other than the central part 111C of the disc 111 according to the shape of the disc 111 of the wheel 11, more specifically, a three-dimensional shape of the spokes 116. In this case as well, the body forming members 132 are combined by the coupling portion 133, and the disc-shaped body 131 can be attached to the disc 111 of the wheel 11.

The wheel cover 13 includes fixing members 134, such as clips, for fixing the body 131, that is, the body forming members 132, to the disc 111. As shown in FIG. 2 and FIG. 4, the fixing members 134 are hooked to the spokes 116 of the disc 111 or inserted in a groove 112G (see also FIG. 3) provided at the outer peripheral part of the rim 112 to be engaged similarly to the above-described existing wheel cap. Thus, the body forming members 132, by extension, the body 131, is fixed to the disc 111 of the wheel 11.

The wheel cover 13 according to the first embodiment has work holes 135 provided in the body 131, that is, the body forming members 132, for allowing the fastening members T (hub nuts, hub bolts, or the like) for assembling the wheel 11 to the hub H to pass for fastening work, as described above. As shown in FIG. 2, the work holes 135 are through-holes formed in the axial direction.

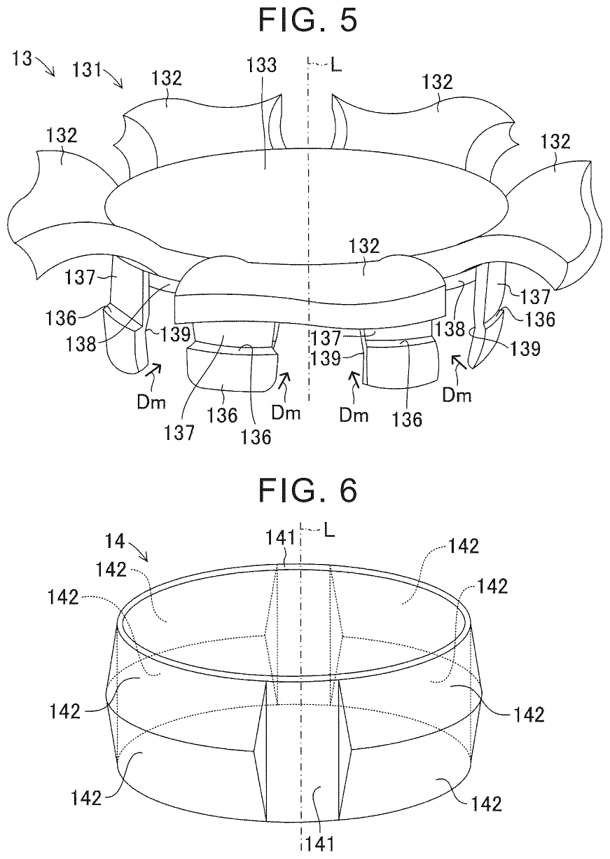

As shown in FIG. 5 in an enlarged view, the wheel cover 13 includes the engaging portions 136. The engaging portions 136 are inserted in the hub hole 113 provided at the central part 111C of the disc 111 of the wheel 11 to engage with the engaged portion 114 provided in the hub hole 113. Each of the engaging portions 136 is provided at the distal end of a leg portion 137 extending toward the hub hole 113, that is, toward the inner side in the axial direction (rotation axis L) from the coupling portion 133 in a state where the wheel cover 13 is attached, at the time of attaching the wheel cover 13 to the wheel 11. Multiple pairs (for example, eight pairs in the present embodiment) of the engaging portion 136 and the leg portion 137 are provided annularly with respect to the coupling portion 133.

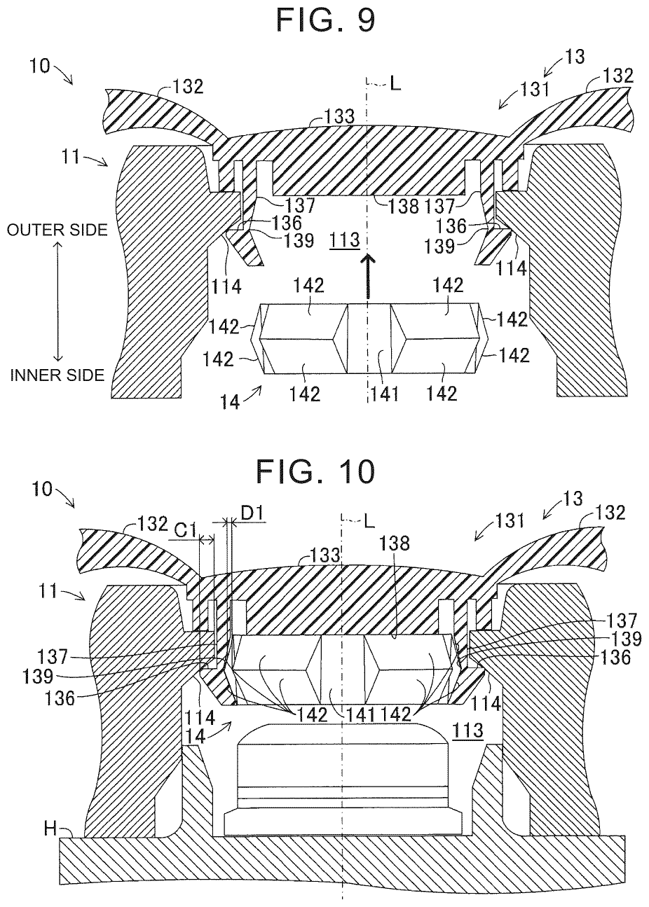

Each of the engaging portions 136 has a hook shape so as to engage with the engaged portion 114 that is a projection. In other words, the engaging portions 136 inserted in the hub hole 113 together with the leg portions 137 are provided so as to protrude outward in the radial direction so as to be opposed to the inner periphery of the hub hole 113, that is, so as to be opposed to the engaged portion 114 (see FIG. 9 and FIG. 10).

Thus, when the engaging portions 136 are inserted to the hub hole 113 in the axial direction together with the leg portions 137, the engaging portions 136 contact with the engaged portion 114. Then, when the engaging portions 136 are further inserted, the leg portions 137 explosively deflect inward in the radial direction, climb over the engaged portion 114, and engage with the engaged portion 114. Here, as indicated by the thick continuous arrows in FIG. 5, of directions in which each of the leg portions 137 explosively deflects, a direction in which the engaging portion 136 separates from the engaged portion 114, that is, a direction to release engagement of the engaging portion 136 with the engaged portion 114 is referred to as a releasing direction Dm.

As will be described later, the wheel cover 13 includes a stopper 138 that positions the restricting member 14 when the restricting member 14 is assembled. The wheel cover 13 includes holding portions 139 respectively formed on the back sides of the engaging portions 136, that is, formed on the inner sides of the engaging portions 136 in the radial direction, and that respectively hold fit holding portions 142 (described later) of the restricting member 14 positioned by the stopper 138. The shapes of the engaging portions 136, the leg portions 137, the stopper 138, and the holding portions 139 will be described in detail later.

The restricting member 14 restricts movement of the engaging portions 136 in the corresponding releasing directions Dm from a state where the engaging portions 136 are engaged with the engaged portion 114. Therefore, as shown in FIG. 6, the restricting member 14 has an annular portion 141 and the fit holding portions 142. The fit holding portions 142 are provided on the outer periphery of the annular portion 141, restrict movement of the engaging portions 136 in the corresponding releasing directions Dm, and being fitted to the holding portions 139 to be held. The annular portion 141 is elastically deformable in the radial direction. The fit holding portions 142 are formed so as to protrude outward in the radial direction with respect to the annular portion 141. Here, at least two or more fit holding portions 142 are preferably formed in the circumferential direction of the annular portion 141, and a case where four fit holding portions 142 are formed is illustrated in the present embodiment.

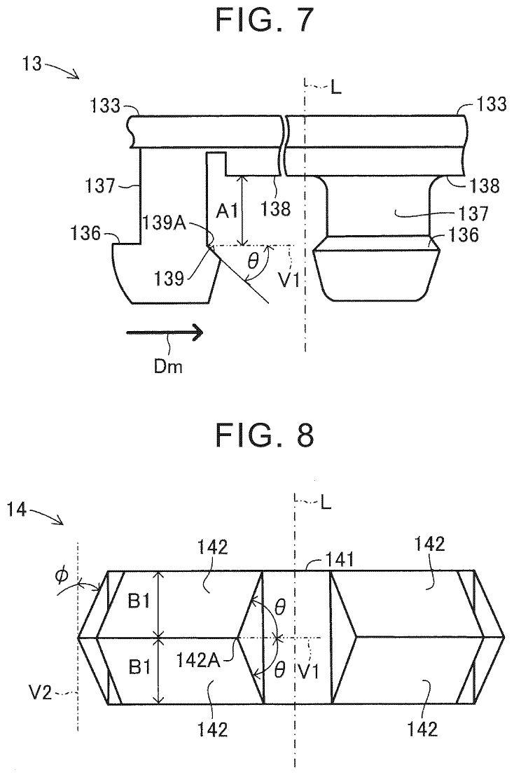

Next, the shapes of the engaging portions 136, the leg portions 137, the stopper 138, and the holding portions 139 of the wheel cover 13 and the shapes of the fit holding portions 142 of the restricting member 14 will be described with reference to FIG. 7 and FIG. 8. The engaging portions 136 need to be engaged with the engaged portion 114 such that, in a state inserted in the hub hole 113, lifting or vibration of the disc 111 at the central part 111C does not occur. Then, as will be described later, the restricting member 14 is inserted on the inner side in the radial direction with respect to the engaging portions 136 in a state where the engaging portions 136 are engaged with the engaged portion 114, with the result that the restricting member 14 needs to be disposed adjacent to the engaging portions 136 in the corresponding releasing directions Dm to restrict movement of the engaging portions 136 in the corresponding releasing directions Dm. Therefore, in a state where the restricting member 14 is inserted on the inner side of the engaging portions 136, a state where the restricting member 14 is held by the holding portions 139 is maintained during normal times, and, for example, the restricting member 14 needs to be released from the holding portions 139 at the time of detaching the wheel cover 13.

Therefore, as indicated by the alternate long and two-short dashed line in FIG. 7, each of the holding portions 139 is formed such that the angle formed between an imaginary plane V1 orthogonal to the axial direction (rotation axis L) and an inclined surface formed so as to protrude inward in the radial direction from the back side of the engaging portion 136 is 0. In other words, each of the holding portions 139 makes a fitting angle θ that is an angle θ with a corresponding one of the fit holding portions 142 of the restricting member 14 positioned by the stopper 138.

On the other hand, as indicated by the alternate long and two-short dashed line in FIG. 8, the fit holding portions 142 are formed such that the angle formed between the imaginary plane V1 orthogonal to the axial direction (rotation axis L) and an inclined surface protruding outward in the radial direction from the annular portion 141 is 0. In other words, as indicated by the alternate long and two-short dashed line in FIG. 8, the fit holding portions 142 are formed such that the angle formed between an imaginary plane V2 parallel to the axial direction (rotation axis L) and the inclined surface is φ(=90°−θ), so-called, approach angle q. In other words, each of the fit holding portions 142 also makes a fitting angle θ that is an angle θ for fitting to a corresponding one of the holding portions 139. Thus, the restricting member 14 is fitted to and held by the holding portions 139 having the same fitting angle θ as the fit holding portions 142 in a state positioned by the stopper 138.

Incidentally, when the restricting member 14 is positioned by the stopper 138, the holding portions 139 and the fit holding portions 142 need to coincide with each other in the axial direction. Therefore, in the wheel cover 13, as shown in FIG. 7, a distance A1 between the stopper 138 and a vertex 139A of the holding portion 139, making the fitting angle θ, is set in the axial direction. On the other hand, in the restricting member 14, as shown in FIG. 8, a distance B1 from an end face on one end side or the other end side of the annular portion 141, which can contact with the stopper 138, to a vertex 142A making the fitting angle θ is set in the axial direction.

Thus, when the distance A1 and the distance B1 are equal to each other, the vertex 139A of the fitting angle θ of the holding portion 139 and the vertex 142A of the fitting angle θ of the fit holding portion 142 coincide with each other, and the restricting member 14 is fitted to and held by the holding portions 139. Incidentally, when the wheel cover 13 and the restricting member 14 are molded from, for example, a resin material, the distance A1 and the distance B1 can ordinarily change due to the influence of water absorption and/or the influence of thermal expansion. In molding the wheel cover 13 and the restricting member 14, allowable tolerances are respectively set for the wheel cover 13 and the restricting member 14. Therefore, realistically, when these dimension change factors are taken into consideration and A1=B1+a incorporating a clearance amount a by which dimensional changes due to the dimension change factors can be absorbed holds, the vertex 139A of the fitting angle θ of the holding portion 139 and the vertex 142A of the fitting angle θ of the fit holding portion 142 coincide with each other, and the restricting member 14 is fitted to and held by the holding portions 139.

Next, assembling of the wheel 11 that is a component of the vehicle wheel structure 10 according to the first embodiment, assembling (attachment) of the wheel cover 13 and the restricting member 14 to the wheel 11, detachment of the wheel 11, and detachment of the wheel cover 13 and the restricting member 14 from the wheel 11 will be described. The following description is illustrative, and assembling (attachment) and detachment may be performed with another method.

Initially, assembling (attachment) of the wheel cover 13 and the restricting member 14 to the wheel 11 will be described. In the first embodiment, the wheel cover 13 is attached to the wheel 11 first. In other words, the body forming members 132 of the body 131 are mainly fixed by hooking the fixing members 134 to the spokes 116 provided in the disc 111 of the wheel 11 and engaging the fixing members 134 with the groove 112G. The engaging portions 136 are inserted together with the leg portions 137 into the hub hole 113 provided in the disc 111 of the wheel 11, with the result that the engaging portions 136 are engaged with the engaged portion 114. With these configurations, the wheel cover 13 is attached to the wheel 11.

Subsequently, in the wheel 11 to which the wheel cover 13 is attached, as indicated by the thick arrow in FIG. 9, the restricting member 14 is inserted from the inner side of the hub hole 113 toward the outer side and assembled. In other words, the fit holding portions 142 of the restricting member 14 are fitted to and held by the holding portions 139 of the wheel cover 13 as shown in FIG. 10. Thus, the fit holding portions 142 of the restricting member 14 contact with the holding portions 139 that are on the back sides of the engaging portions 136 to restrict movement of the engaging portions 136 in the corresponding releasing directions Dm.

Here, as shown in FIG. 10, an engagement overlap width C1 in a case where the engaging portions 136 are engaged with the engaged portion 114 and a maximum clearance D1 that can occur due to dimension change factors between the inside diameter of the holding portion 139 and the outside diameter of the fit holding portion 142 in a case where the holding portion 139 is fitted to the fit holding portion 142 are considered. In this case, in a case where the maximum clearance D1 is smaller than the engagement overlap width C1, even if the engaging portions 136 move in the corresponding releasing directions Dm, engagement of the engaging portions 136 with the engaged portion 114 is not released.

In other words, in a case where the relationship C1>D1 holds, the restricting member 14 restricts movement of the engaging portions 136 in the corresponding releasing directions Dm, so releasing engagement of the engaging portions 136 with the engaged portion 114 is suppressed. Thus, in a state where the wheel 11 is assembled to the hub H, that is, in a state where the vehicle drives, engagement of the engaging portions 136 with the engaged portion 114 is not released, and an engaged state is maintained.

In this way, in a state where the wheel cover 13 is attached to the wheel 11 and the restricting member 14 is assembled, the wheel 11 is assembled to the hub Has shown in FIG. 10. In this case, the fastening members T are inserted through the work holes 135 provided in the body 131 (body forming members 132) of the wheel cover 13, and the fastening members T are fastened to the hub H by fastening work to assemble the wheel 11 to the hub H. In other words, in the first embodiment, after the wheel cover 13 is attached to the wheel 11 and the restricting member 14 is assembled, the wheel 11 is assembled to the hub H.

Next, detachment of the wheel 11 and detachment of the wheel cover 13 and the restricting member 14 from the wheel 11 will be described. Detachment of the wheel 11, the wheel cover 13, and the restricting member 14 is performed in order reverse to that in a case of assembling (attachment). Specifically, initially, the wheel 11 fastened and assembled to the hub H by the fastening members T is detached from the hub H. Therefore, the fastening members T are loosened and detached by using the work holes 135, and the wheel 11 is detached from the hub H.

Subsequently, the restricting member 14 is detached from the inner side of the detached wheel 11. In other words, the restricting member 14 of which the fit holding portions 142 are fitted to the holding portions 139 of the wheel cover 13 is pulled out from the outer side of the hub hole 113 toward the inner side and detached. Thus, the engaging portions 136 of the wheel cover 13 are allowed to move in the corresponding releasing directions Dm as a result of deflection of the leg portions 137.

Lastly, the wheel cover 13 is detached from the disc 111 of the wheel 11. In this case, for example, engagement of the fixing members 134 fixing the body forming members 132 of the body 131 to the disc 111 is released, and then the coupling portion 133 is detached from the inner side toward the outer side in the axial direction. In this case, since the restricting member 14 has been already detached, as the engaging portions 136 move toward the outer side in the axial direction together with the coupling portion 133, the engaging portions 136 move in the corresponding releasing directions Dm along inclined surfaces respectively formed at engaging parts of the engaged portion 114 with the engaging portions 136. Thus, engagement of the engaging portions 136 with the engaged portion 114 is released, and the wheel cover 13 is allowed to be detached.

As can be understood from the above description, the vehicle wheel structure 10 according to the first embodiment includes: the wheel 11 that supports the tire 12 and that is assembled to the vehicle; the wheel cover 13 engaged with the wheel 11 at least at the central part 111C of the disc 111 that is a component of the wheel 11, the wheel cover 13 in a state attached to the wheel 11 including the body 131 formed so as to cover a design surface that is a surface, corresponding to an outer side of the vehicle, of the disc 111 when the wheel 11 is assembled to the vehicle and the engaging portions 136 that are provided on the body 131 and that engage with the engaged portion 114 provided at the central part 111C of the disc 111; and the restricting member 14 that restricts movement of the engaging portions 136 in the corresponding releasing directions Dm to release engagement with the engaged portion 114 in a state where the engaging portions 136 are engaged with the engaged portion 114.

In this case, the restricting member 14 is disposed adjacent to the engaging portions 136 in the corresponding releasing directions Dm.

In these cases, the wheel 11 has the hub hole 113 provided so as to extend through at the central part 111C of the disc 111 along the rotation axis L of the wheel 11 to be fixed to the hub H of the vehicle, the engaging portions 136 are disposed so as to be opposed to the inner periphery of the hub hole 113 so as to engage with the engaged portion 114 provided on the inner periphery of the hub hole 113, and the restricting member 14 is disposed on the back side across each of the engaging portions 136 from the engaging side at which the engaging portion 136 is engaged with the engaged portion 114 to restrict movement of the engaging portions 136 in the corresponding releasing directions Dm away from the engaged portion 114.

In this case, in a state where the body 131 is attached to the wheel 11, the restricting member 14 is inserted to the hub hole 113 from the inner side of the vehicle to which the wheel 11 is assembled, and is disposed on the back side of each of the engaging portions 136.

In this case, the restricting member 14 is held by the holding portions 139 each provided on the back side of a corresponding one of the engaging portions 136.

In this case, the restricting member 14 has an annular shape so as to be held by the holding portions 139.

In this case, the wheel cover 13 and the restricting member 14 are molded from a resin material.

In this case, the body 131 has the plurality of body forming members 132 and the coupling portion 133 that couples the body forming members 132 in the circumferential direction of the disc 111 in a state attached to the wheel 11.

In this case, each of the body forming members 132 has a fan shape, and the coupling portion 133 couples the plurality of body forming members 132 at the central part 111C of the disc 111 in a state attached to the wheel 11.

In this case, the body 131 has the work holes 135 that allow the fastening members T for assembling the wheel 11 to the hub H of the vehicle to pass for fastening work in a state where the wheel cover 13 is attached to the wheel 11.

With the vehicle wheel structure 10 according to the first embodiment, the restricting member 14 is capable of restricting movement of the engaging portions 136 engaged with the engaged portion 114 at the central part 111C of the wheel 11 in the corresponding releasing directions Dm when the restricting member 14 is inserted from the inner side into the hub hole 113 and the fit holding portions 142 are fitted to and held by the holding portions 139. Thus, with the vehicle wheel structure 10, even when external force acts on the wheel cover 13 in a detachment direction, an engaged state of the engaging portions 136 with the engaged portion 114 is maintained. Therefore, the vehicle wheel structure 10 is capable of suppressing detachment of the wheel cover 13 from the wheel 11.

With the vehicle wheel structure 10, even when external force acts on the wheel cover 13, lifting of the central part 111C is suppressed, so, even when centrifugal force acts, for example, movement of the wheel cover 13 in the radial direction is suppressed. Therefore, with the vehicle wheel structure 10, detachment of the wheel cover 13 can be suppressed with the fixing members 134 together with the engaging portions 136. Furthermore, with the vehicle wheel structure 10, lifting of the central part 111C is suppressed even when external force acts on the wheel cover 13, so it is possible to suppress generation of noise even when vibration occurs in the wheel cover 13.

### 2. Second Embodiment

In the above-described first embodiment, the vehicle wheel structure 10 includes the annular restricting member 14, and movement of the engaging portions 136 in the corresponding releasing directions Dm is restricted by inserting and assembling the restricting member 14 from the inner side of the hub hole 113 toward the outer side. For this reason, in the vehicle wheel structure 10 according to the first embodiment, assembling of the wheel cover 13 and the restricting member 14 before the wheel 11 is assembled to the hub H has been described.

A vehicle wheel structure 10 according to the second embodiment includes a cylindrical restricting member 15 (described later), and movement of the engaging portions 136 in the corresponding releasing directions Dm is restricted by inserting the restricting member 15 from the outer side of the hub hole 113 toward the inner side. In the description of the vehicle wheel structure 10 according to the second embodiment, like reference signs denote the same portions as those of the first embodiment, and the detailed description is omitted.

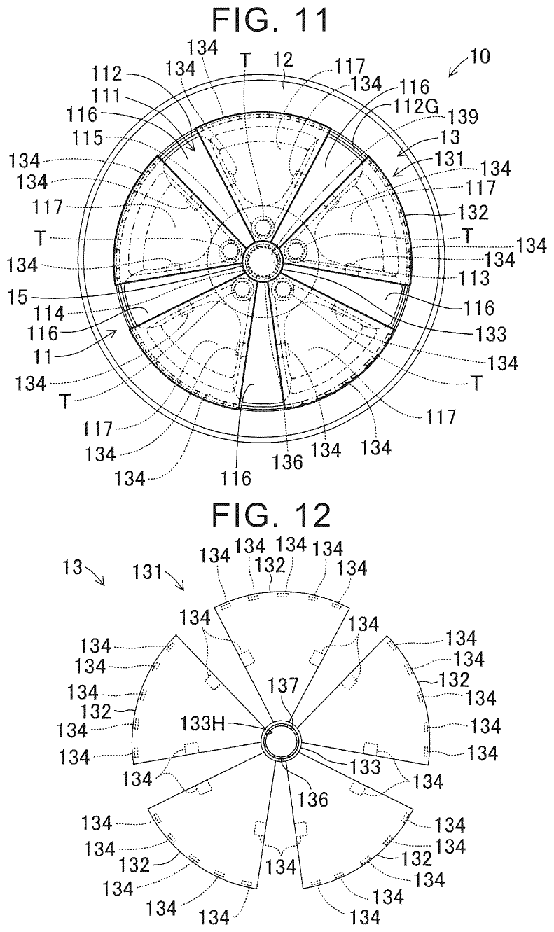

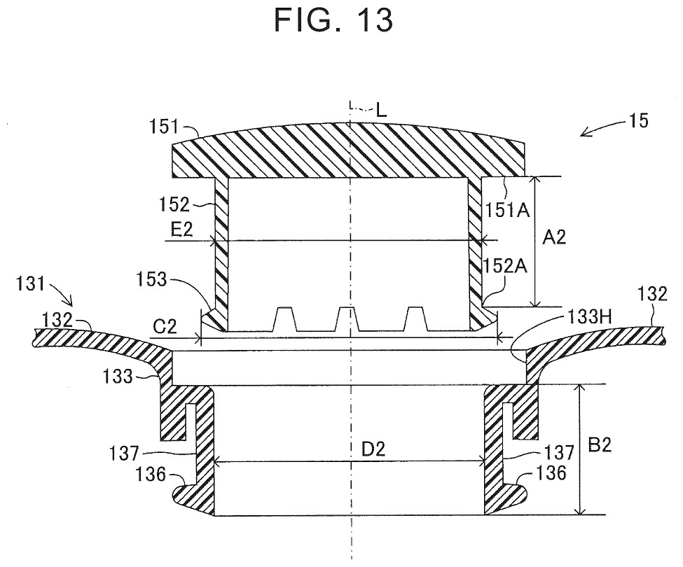

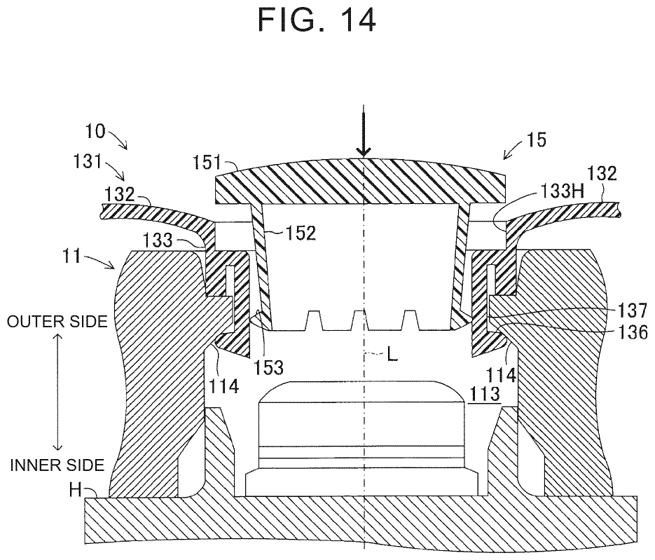

As shown in FIG. 11, the vehicle wheel structure 10 according to the second embodiment also includes the wheel 11 and the tire 12 described in the first embodiment, and the wheel cover 13 is attached to the wheel 11. However, as shown in FIG. 12, in the wheel cover 13 according to the second embodiment, the work hole 135 described in the first embodiment is omitted. In the wheel cover 13 according to the second embodiment, the coupling portion 133 has a through-hole 133H disposed coaxially with the hub hole 113 in a state attached to the wheel 11. Then, as shown in FIG. 13, the cylindrical restricting member 15 is inserted in the through-hole 133H.

In the present embodiment, to insert a large-diameter decorative portion 151 of the restricting member 15 (described later) and a contact portion 152 smaller in diameter than the decorative portion 151, a case where the through-hole 133H is stepped in the axial direction is illustrated. However, the shape of the through-hole 133H in the axial direction is not limited to the stepped shape, and may be, of course, a shape having the same inside diameter.

The restricting member 15 includes the decorative portion 151 to be decorated, the contact portion 152, and an engagement holding portion 153. The decorative portion 151 is a surface exposed to the design surface of the wheel 11 in a state where the restricting member 15 is inserted in the through-hole 133H and is decorated with, for example, an ornament or the like.

The contact portion 152 is formed in a cylindrical shape smaller in diameter than the outside diameter of the decorative portion 151. In a state where the contact portion 152 is inserted in the through-hole 133H, the contact portion 152 is disposed on the back side of the engaging portions 136 engaged with the engaged portion 114 provided in the hub hole 113. Thus, the contact portion 152 restricts movement of the engaging portions 136 in the corresponding releasing directions Dm (see FIG. 15).

The engagement holding portion 153 is provided at the distal end of the contact portion 152 in a direction in which the restricting member 15 is inserted to the through-hole 133H and the hub hole 113, for example, the axial direction. Then, the engagement holding portion 153 is engaged with the engaging portions 136, more specifically, the distal ends of the engaging portions 136 in the axial direction to hold the restricting member 15 (see FIG. 15).

Here, the shape of the through-hole 133H of the wheel cover 13 and the shapes of the contact portion 152 and engagement holding portion 153 of the restricting member 15 will be described with reference to FIG. 13. As described above, the engaging portions 136 need to be engaged with the engaged portion 114 such that, in a state inserted in the hub hole 113, lifting or vibration of the disc 111 at the central part 111C does not occur. Then, as will be described later, the restricting member 15 needs to restrict movement of the engaging portions 136 in the corresponding releasing directions Dm by being inserted to the through-hole 133H in a state where the engaging portions 136 are engaged with the engaged portion 114. Then, in a state where the restricting member 15 is inserted in the through-hole 133H, a state where the engagement holding portion 153 is engaged with the engaging portions 136 is maintained during normal times, and, for example, engagement of the engagement holding portion 153 with the engaging portions 136 needs to be released at the time of detaching the wheel cover 13.

For this reason, as shown in FIG. 13, in the restricting member 15, the length of the contact portion 152, more specifically, a distance A2 to a coupling position 152A between the contact portion 152 and the engagement holding portion 153, from a contact surface 151A of the decorative portion 151 positioned by the large-diameter part of the through-hole 133H in a state where the restricting member 15 is inserted to the through-hole 133H is set. In the wheel cover 13, a distance B2 corresponding to the length (depth) in the axial direction of the small-diameter part of the through-hole 133H, formed by the leg portions 137 such that the contact portion 152 is inserted, is set.

Thus, in a case where the distance A2 is longer than the distance B2 (A2>B2), the engagement holding portion 153 is located beyond the engaging portions 136 in the axial direction, so the restricting member 15 is held in a manner such that the engagement holding portion 153 is engaged with the engaging portions 136. Incidentally, in order for the engagement holding portion 153 to maintain engagement with the engaging portions 136, the outside diameter C2 of the engagement holding portion 153 is set so as to be larger than the inside diameter D2 of the small-diameter part of the through-hole 133H. Specifically, when, in consideration of a deflection amount B toward the inner side in the radial direction of the engagement holding portion 153, C2=D2+β holds, the engagement holding portion 153 can maintain engagement with the engaging portions 136.

The contact portion 152 restricts movement of the engaging portions 136 in the corresponding releasing directions Dm, so the outside diameter E2 of the contact portion 152 is set. In this case, when the outside diameter E2 of the contact portion 152 and the inside diameter D2 of the small-diameter part of the through-hole 133H are equal to each other (E2=D2), the engaging portions 136 cannot move even when the engaging portions 136 attempt to move in the corresponding releasing directions Dm, so engagement of the engaging portions 136 with the engaged portion 114 is not released. Incidentally, when the wheel cover 13 and the restricting member 15 are molded from, for example, a resin material, the outside diameter E2 and the inside diameter D2 can ordinarily change due to the influence of water absorption and/or the influence of thermal expansion. In molding the contact portion 152 and the through-hole 133H, that is, the leg portions 137, allowable tolerances are respectively set for the contact portion 152 and the through-hole 133H, that is, the leg portions 137. Therefore, realistically, when these dimension change factors are taken into consideration and E2=D2+y that incorporates a clearance amount y by which dimensional changes due to the dimensional change factors holds, the contact portion 152 can be disposed on the back sides of the engaging portions 136, and movement of the engaging portions 136 in the corresponding releasing directions Dm can be restricted.

Next, assembling of the wheel 11 that is a component of the vehicle wheel structure 10 according to the second embodiment, assembling (attachment) of the wheel cover 13 and the restricting member 15 to the wheel 11, detachment of the wheel 11, and detachment of the wheel cover 13 and the restricting member 15 from the wheel 11 will be described. In the second embodiment as well, the following description is illustrative, and assembling (attachment) and detachment may be performed with another method.

In the second embodiment, initially, the wheel 11 is initially assembled to the hub H. In other words, in the second embodiment, before the wheel cover 13 and the restricting member 15 are attached, the fastening members T are fastened to the hub H by fastening work, and the wheel 11 is assembled to the hub H.

Then, in the second embodiment, in a state where the wheel 11 is assembled to the hub H, the wheel cover 13 is attached to the wheel 11. In other words, the body forming members 132 of the body 131 are mainly fixed by hooking the fixing members 134 to the spokes 116 provided in the disc 111 of the wheel 11 and inserting the fixing members 134 to the groove 112G.

Furthermore, as shown in FIG. 14, the engaging portions 136 are inserted together with the leg portions 137 into the hub hole 113 provided in the disc 111 of the wheel 11, with the result that the engaging portions 136 are engaged with the engaged portion 114. With these configurations, the wheel cover 13 is attached to the wheel 11. Here, in the wheel cover 13 attached to the wheel 11, the through-hole 133H and the hub hole 113 are coaxially disposed.

Subsequently, in the wheel cover 13 attached to the wheel 11, as indicated by the thick arrow in FIG. 14, the restricting member 15 is inserted from the outer side of the vehicle toward the inner side to be assembled. In other words, the engagement holding portion 153 of the restricting member 15 is engaged with the engaging portions 136 as shown in FIG. 15. Thus, the contact portion 152 of the restricting member 15 is disposed on the back sides of the engaging portions 136 to restrict movement of the engaging portions 136 in the corresponding releasing directions Dm.

In this way, in the second embodiment, the wheel cover 13 is attached to the wheel 11 assembled to the hub H. After that, the restricting member 15 is inserted in the through-hole 133H to be assembled.

Next, detachment of the wheel 11 and detachment of the wheel cover 13 and the restricting member 15 from the wheel 11 will be described. Detachment of the wheel 11, the wheel cover 13, and the restricting member 15 is performed in order reverse to that in a case of assembling (attachment). Specifically, initially, the restricting member 15 is pulled out from the inner side of the vehicle toward the outer side to be detached. In other words, the restricting member 15 of which the engagement holding portion 153 is engaged with the engaging portions 136 of the wheel cover 13 is detached. Here, when the restricting member 15 moves from the inner side toward the outer side in the axial direction, the engaging parts of the engagement holding portion 153, with which the engaging portions 136 are engaged, each form an inclined surface formed to deflect inward in the radial direction with movement of the restricting member 15 as shown in FIG. 15. Thus, the restricting member 15 is allowed to be pulled out from the through-hole 133H to be detached.

Subsequently, the wheel cover 13 is detached from the disc 111 of the wheel 11. In this case, for example, engagement of the fixing members 134 fixing the body forming members 132 of the body 131 to the disc 111 is released, and then the coupling portion 133 is detached from the inner side toward the outer side in the axial direction. In this case, since the restricting member 15 has been already detached, as the engaging portions 136 move toward the outer side in the axial direction together with the coupling portion 133, the engaging portions 136 move in the corresponding releasing directions Dm along inclined surfaces respectively formed at engaging parts of the engaged portion 114 with the engaging portions 136 due to deflection of the leg portions 137. Thus, engagement of the engaging portions 136 with the engaged portion 114 is released, and detachment of the wheel cover 13 is complete.

Lastly, the wheel 11 fastened and assembled to the hub H by the fastening members T is detached from the hub H. In this case, since detachment of the wheel cover 13 is already complete, the fastening members T are loosened to be detached, and the wheel 11 is detached from the hub H.

As can be understood from the above description, the vehicle wheel structure 10 according to the second embodiment includes: the wheel 11 that supports the tire 12 and that is assembled to the vehicle; the wheel cover 13 engaged with the wheel 11 at least at the central part 111C of the disc 111 that is a component of the wheel 11, the wheel cover 13 in a state attached to the wheel 11 including the body 131 formed so as to cover a design surface that is a surface, corresponding to an outer side of the vehicle, of the disc 111 when the wheel 11 is assembled to the vehicle and the engaging portions 136 that are provided on the body 131 and that engage with the engaged portion 114 provided at the central part 111C of the disc 111; and the restricting member 15 that restricts movement of the engaging portions 136 in the corresponding releasing directions Dm to release engagement with the engaged portion 114 in a state where the engaging portions 136 are engaged with the engaged portion 114.

In this case, the restricting member 15 is disposed adjacent to the engaging portions 136 in the corresponding releasing directions Dm.

In these cases, the wheel 11 has the hub hole 113 provided so as to extend through at the central part 111C of the disc 111 along the rotation axis L of the wheel 11 to be fixed to the hub H of the vehicle, the engaging portions 136 are disposed so as to be opposed to the inner periphery of the hub hole 113 so as to engage with the engaged portion 114 provided on the inner periphery of the hub hole 113, and the restricting member 15 is disposed on the back side across each of the engaging portions 136 from the engaging side at which the engaging portion 136 is engaged with the engaged portion 114 to restrict movement of the engaging portions 136 in the corresponding releasing directions Dm away from the engaged portion 114.

In this case, the body 131 has the through-hole 133H disposed coaxially with the hub hole 113 in a state attached to the wheel 11, and the restricting member 15 is inserted to the through-hole 133H and the hub hole 113 from the outer side of the vehicle and disposed on the back sides of the engaging portions 136 in a state where the wheel 11 is assembled to the vehicle and the body 131 is attached to the wheel 11.

In this case, the restricting member 15 has the contact portion 152 that can contact with at least the back sides of the engaging portions 136, and the engagement holding portion 153 that is provided at the distal end of the contact portion 152 in the direction in which the restricting member 15 is inserted to the through-hole 133H and the hub hole 113 and that is engaged with the engaging portions 136 to hold the restricting member 15.

With the vehicle wheel structure 10 according to the second embodiment, the restricting member 15 is inserted to the hub hole 113 from the outer side, and the engagement holding portion 153 is engaged with and held by the engaging portions 136. Then, the contact portion 152 can restrict movement of the engaging portions 136 in the corresponding releasing directions Dm, and the engaging portions 136 are engaged with the engaged portion 114 at the central part 111C of the wheel 11. Thus, with the vehicle wheel structure 10 according to the second embodiment as well, similar advantageous effects to those of the above-described first embodiment are obtained.

### 3. Modifications

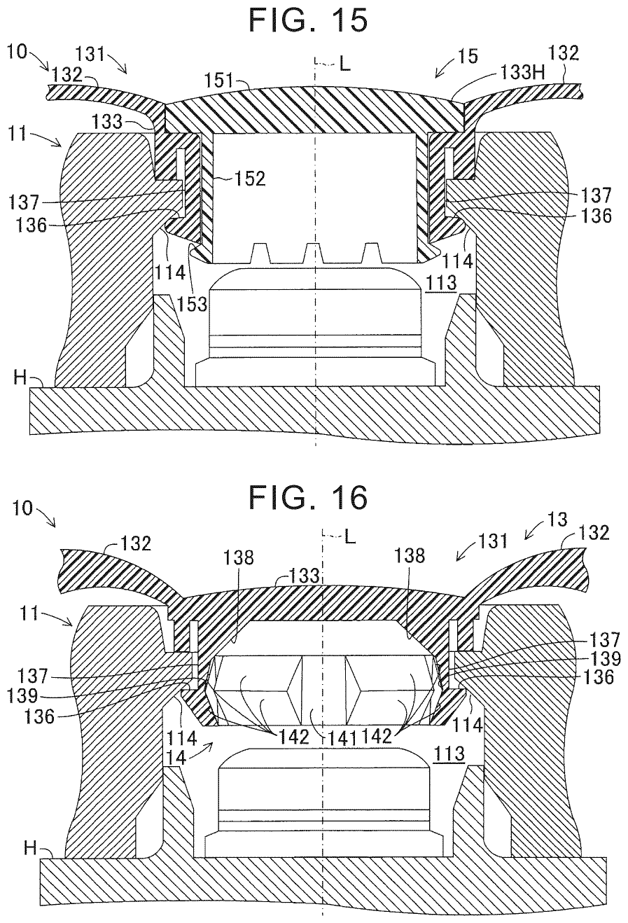

In the first embodiment, the stopper 138 has a planar shape orthogonal to the axial direction in a sectional shape so as to contact with the end face of the annular portion 141 (fit holding portion 142) of the restricting member 14 in the axial direction. Alternatively, as shown in FIG. 16, the stopper 138 may have an inclined surface in a sectional shape so that the restricting member 14 is coupled to the engaging portions 136, more specifically, the leg portions 137. In this case as well, the stopper 138 can position the restricting member 14 in the axial direction. Therefore, similar advantageous effects to those of the above-described first embodiment are obtained.

In the first embodiment, the engaging portions 136 and the holding portions 139 are disposed at narrow intervals in the circumferential direction, and the restricting member 14 is inserted from the inner side of the hub hole 113 to fit the holding portions 139 and the fit holding portions 142 to each other. Thus, the restricting member 14 is held. In other words, as in the case of the first embodiment, when the holding portions 139 are disposed tightly at narrow intervals in the circumferential direction, the holding portions 139 and the fit holding portions 142 can be fitted to each other without rotating the restricting member 14 around the rotation axis L even when the fit holding portions 142 of the restricting member 14 are divided. Thus, the restricting member 14 is appropriately held to make it possible to restrict movement of the engaging portions 136, corresponding to the holding portions 139 fitted to the fit holding portions 142, in the corresponding releasing directions Dm.

Incidentally, it is assumed, for example, when two or four narrow-width engaging portions 136, that is, the holding portions 139, are formed at equal intervals in the circumferential direction and two or four fit holding portions 142, adapted to the width of the holding portion 139, at equal intervals in the circumferential direction of the annular portion 141, that is, a case where the holding portions 139 and the fit holding portions 142 are disposed relatively sparsely. In this case, merely, only inserting the restricting member 14 cannot lead to engagement between the holding portions 139 and the fit holding portions 142 with each other.

For this reason, in a case where the holding portions 139 and the fit holding portions 142 are disposed relatively sparsely, after the restricting member 14 is inserted, the restricting member 14 is rotated by about an appropriate angle (for example, about 90 degrees or about 45 degrees) such that the fit holding portions 142 are fitted to the holding portions 139. Thus, it is possible to fit the holding portions 139 and the fit holding portions 142 to each other, so the restricting member 14 is held and can restrict movement of the engaging portions 136 in the corresponding releasing directions Dm. Therefore, similar advantageous effects to those of the above-described first embodiment are obtained.

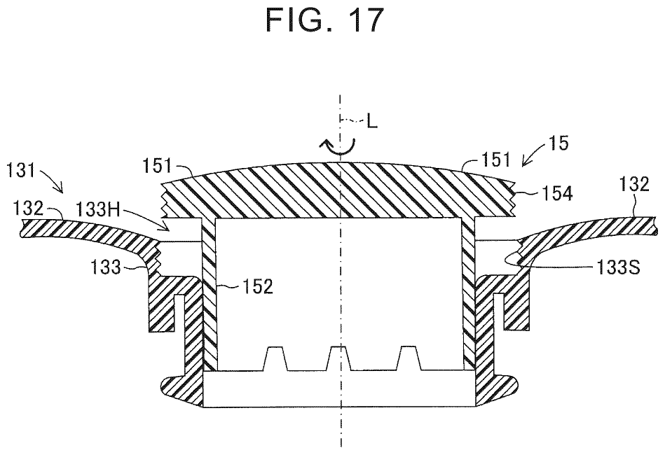

In the second embodiment, the restricting member 15 has the engagement holding portion 153, and the engagement holding portion 153 is engaged with the engaging portions 136 to fix the restricting member 15 to the wheel cover 13. Alternatively, as shown in FIG. 17, for example, a screw portion 154 is provided on the outer periphery of the decorative portion 151, a screw portion 133S is provided on the inner periphery of the large-diameter part of the through-hole 133H, and the restricting member 15 can be fixed to the wheel cover 13 by screwing the screw portion 154 to the screw portion 133S. In this case, as shown in FIG. 17, the engagement holding portion 153 provided in the second embodiment is omitted, so the restricting member 15 has the decorative portion 151, the contact portion 152, and the screw portion 154.

In this case as well, the restricting member 15 can be fixed to the wheel cover 13, and the contact portion 152 can restrict movement of the engaging portions 136 in the corresponding releasing directions Dm. Therefore, similar advantageous effects to those of the second embodiment, that is, the first embodiment, are obtained. When the contact portion 152 is formed such that the sectional shape in the radial direction is an elliptical shape, the engaging portions 136 to be brought into contact with the contact portion 152 can be selectively changed according to the rotation position of the restricting member 15. In this case as well, the contact portion 152 can restrict movement of the engaging portions 136 in the corresponding releasing directions Dm.

In the above-described first embodiment and second embodiment, a case where the body 131 of the wheel cover 13 that is a component of the vehicle wheel structure 10 is made up of the plurality of (specifically, five) body forming members 132 has been illustrated and described. However, the body 131 does not need to be made up of a plurality of body forming members 132 and may be made up of a single disc-shaped member. In this case as well, when the vehicle wheel structure 10 includes the above-described restricting member 14 or restricting member 15, similar advantageous effects to those of the first embodiment and the second embodiment are obtained.

In the above-described first embodiment, a case where the restricting member 14 that is a component of the vehicle wheel structure 10 has the annular portion 141 has been illustrated and described. However, the restricting member 14 may have a plate-shaped circular plate portion, and the fit holding portions 142 may be formed at the outer periphery of the circular plate portion. In this case as well, the fit holding portions 142 are fitted to the holding portions 139 to hold the restricting member 14, so similar advantageous effects to those of the above-described first embodiment are obtained.

Here, a first aspect of the disclosure provides a vehicle wheel structure. The vehicle wheel structure includes: a wheel configured to support a tire and be assembled to a vehicle; a wheel attachment member engaged with the wheel at least at a central part of a disc that is a component of the wheel, the wheel attachment member in a state attached to the wheel including a body formed so as to cover a surface, corresponding to an outer side of the vehicle, of the disc when the wheel is assembled to the vehicle and an engaging portion provided on the body and configured to engage with an engaged portion provided at the central part of the disc; and a restricting member configured to restrict movement of the engaging portion in a releasing direction to release engagement with the engaged portion in a state where the engaging portion is engaged with the engaged portion.

A vehicle wheel structure according to a second aspect of the disclosure is configured such that, in the vehicle wheel structure according to the first aspect, the restricting member is disposed adjacent to the engaging portion in the releasing direction.

A vehicle wheel structure according to a third aspect of the disclosure is configured such that, in the vehicle wheel structure according to the first aspect or the second aspect, the wheel has a hub hole provided so as to extend through at the central part of the disc along a rotation axis of the wheel to be fixed to a hub of the vehicle, the engaging portion is disposed so as to be opposed to an inner periphery of the hub hole so as to engage with the engaged portion provided on the inner periphery of the hub hole, and the restricting member is configured to be disposed on a back side across the engaging portion from an engaging side at which the engaging portion is engaged with the engaged portion to restrict movement of the engaging portion in the releasing direction away from the engaged portion.

A vehicle wheel structure according to a fourth aspect of the disclosure is configured such that, in the vehicle wheel structure according to the third aspect, in a state where the body is attached to the wheel, the restricting member is inserted to the hub hole from an inner side of the vehicle to which the wheel is assembled, and is disposed on the back side of the engaging portion.

A vehicle wheel structure according to a fifth aspect of the disclosure is configured such that, in the vehicle wheel structure according to the fourth aspect, the restricting member is configured to be held by a holding portion provided on the back side of the engaging portion.

A vehicle wheel structure according to a sixth aspect of the disclosure is configured such that, in the vehicle wheel structure according to the fifth aspect, the restricting member has an annular shape or a disc shape so as to be held by the holding portion.

A vehicle wheel structure according to a seventh aspect of the disclosure is configured such that, in the vehicle wheel structure according to the third aspect, the body has a through-hole disposed coaxially with the hub hole in a state attached to the wheel, and, in a state where the wheel is assembled to the vehicle and the body is attached to the wheel, the restricting member is inserted in the through-hole and the hub hole from an outer side of the vehicle and is disposed on the back side of the engaging portion.

A vehicle wheel structure according to an eighth aspect of the disclosure is configured such that, in the vehicle wheel structure according to the seventh aspect, the restricting member includes a contact portion configured to contact with at least the back side of the engaging portion, and an engagement holding portion configured to hold the restricting member when provided at a distal end of the contact portion in an insertion direction of the restricting member to the through-hole and the hub hole and engaged with the engaging portion.

A vehicle wheel structure according to an eighth aspect of the disclosure is configured such that, in the vehicle wheel structure according to the seventh aspect, the restricting member includes a contact portion configured to contact with at least the back side of the engaging portion, and a screw portion configured to be screwed to a thread formed on an inner periphery of the through-hole of the body.

A vehicle wheel structure according to a tenth aspect of the disclosure is configured such that, in the vehicle wheel structure according to any one of the first aspect to the ninth aspect, the wheel attachment member and the restricting member are molded from, a resin material.

A vehicle wheel structure according to an eleventh aspect of the disclosure is configured such that, in the vehicle wheel structure according to any one of the first aspect to the tenth aspect, the body has a plurality of body forming members and a coupling portion configured to couple the body forming members in a circumferential direction of the disc in a state attached to the wheel.

A vehicle wheel structure according to a twelfth aspect of the disclosure is configured such that, in the vehicle wheel structure according to the eleventh aspect, the body forming member has a fan shape, and the coupling portion is configured to couple the plurality of body forming members at the central part of the disc in a state attached to the wheel.

A vehicle wheel structure according to a thirteenth aspect of the disclosure is configured such that, in the vehicle wheel structure according to any one of the fourth aspect to the sixth aspect, the body has a work hole configured to, in a state where the wheel attachment member is attached to the wheel, allow a fastening member for assembling the wheel to a hub of the vehicle to pass for fastening work.

What is claimed is:

1. A vehicle wheel structure comprising:
a wheel configured to support a tire and be assembled to a vehicle;
a wheel attachment member engaged with the wheel at least at a central part of a disc that is a component of the wheel, the wheel attachment member in a state attached to the wheel including a body formed so as to cover a surface, corresponding to an outer side of the vehicle, of the disc when the wheel is assembled to the vehicle and an engaging portion provided on the body and configured to engage with an engaged portion provided at the central part of the disc; and
a restricting member configured to restrict movement of the engaging portion in a releasing direction to release engagement with the engaged portion in a state where the engaging portion is engaged with the engaged portion.

2. The vehicle wheel structure according to claim 1, wherein the restricting member is disposed adjacent to the engaging portion in the releasing direction.

3. The vehicle wheel structure according to claim 1, wherein:
the wheel has a hub hole provided so as to extend through at the central part of the disc along a rotation axis of the wheel to be fixed to a hub of the vehicle;
the engaging portion is disposed so as to be opposed to an inner periphery of the hub hole so as to engage with the engaged portion provided on the inner periphery of the hub hole; and
the restricting member is configured to be disposed on a back side across the engaging portion from an engaging side at which the engaging portion is engaged with the engaged portion to restrict movement of the engaging portion in the releasing direction away from the engaged portion.

4. The vehicle wheel structure according to claim 3, wherein, in a state where the body is attached to the wheel, the restricting member is inserted to the hub hole from an inner side of the vehicle to which the wheel is assembled, and is disposed on the back side of the engaging portion.

5. The vehicle wheel structure according to claim 4, wherein the restricting member is configured to be held by a holding portion provided on the back side of the engaging portion.

6. The vehicle wheel structure according to claim 5, wherein the restricting member has an annular shape or a disc shape so as to be held by the holding portion.

7. The vehicle wheel structure according to claim 3, wherein:
the body has a through-hole disposed coaxially with the hub hole in a state attached to the wheel; and
in a state where the wheel is assembled to the vehicle and the body is attached to the wheel, the restricting member is inserted in the through-hole and the hub hole from an outer side of the vehicle and is disposed on the back side of the engaging portion.

8. The vehicle wheel structure according to claim 7, wherein the restricting member includes
a contact portion configured to contact with at least the back side of the engaging portion, and
an engagement holding portion configured to hold the restricting member when provided at a distal end of the contact portion in an insertion direction of the restricting member to the through-hole and the hub hole and engaged with the engaging portion.

9. The vehicle wheel structure according to claim 7, wherein the restricting member includes
a contact portion configured to contact with at least the back side of the engaging portion, and
a screw portion configured to be screwed to a thread formed on an inner periphery of the through-hole of the body.

10. The vehicle wheel structure according to claim 1, wherein the wheel attachment member and the restricting member are molded from a resin material.

11. The vehicle wheel structure according to claim 1, wherein the body has a plurality of body forming members and a coupling portion configured to couple the body forming members in a circumferential direction of the disc in a state attached to the wheel.

12. The vehicle wheel structure according to claim 11, wherein:
each of the body forming members has a fan shape; and
the coupling portion is configured to couple the plurality of body forming members at the central part of the disc in a state attached to the wheel.

13. The vehicle wheel structure according to claim 4, wherein the body has a work hole configured to, in a state where the wheel attachment member is attached to the wheel, allow a fastening member for assembling the wheel to a hub of the vehicle to pass for fastening work.
